(19) United States
(12) Patent Application Publication
(10) Pub. No.: US 2011/0058059 A1
(43) Pub. Date: Mar. 10, 2011

(54) Object-Image Searching Apparatus

(75) Inventor: Masayoshi OKAMOTO, Daito-shi (JP)

(73) Assignee: Sanyo Electric Co., Ltd., Osaka (JP)

(21) Appl. No.: 12/876,477

(22) Filed: Sep. 7, 2010

(30) Foreign Application Priority Data
Sep. 7, 2009 (JP) 2009-206293

(51) Int. Cl. H04N 5/228; G06K 9/68

(52) U.S. Cl. 348/222.1; 382/218; 348/E05.031

(57) ABSTRACT

An object-image searching apparatus includes a fetcher. A fetcher repeatedly fetches an object scene image. A first searcher searches an object image that matches a registered object image from the object scene image fetched by the fetcher. An acceptor accepts a designating manipulation for designating the object image on the object scene image fetched by the fetcher. A second searcher searches a predetermined object image that matches the object image designated by the designating manipulation from among a plurality of predetermined object images. A definer defines, as the registered object image, the predetermined object image discovered by the second searcher.

### CROSS REFERENCE OF RELATED APPLICATION

The disclosure of Japanese Patent Application No. 2009-206293, which was filed on Sep. 7, 2009, is incorporated herein by reference.

### BACKGROUND OF THE INVENTION

1. Field of the Invention

The present invention relates to an object-image searching apparatus. More particularly, the present invention relates to an object-image searching apparatus which searches from an object scene image an object image that matches a registered object image.

2. Description of the Related Art

According to one example of this type of apparatus, a data-collection terminal device is installed at a customer service counter, and an analyzing section is installed at an information processing center. Both the data-collection terminal device and the analyzing section store a plurality of face images, as dictionary data, used for checking with a face image of a customer, and display a face image that resembles the face image of the customer, together with resemble-degree information, on a data display section.

However, the face images stored in the data-collection terminal device are limited to a proportion of high-importance face images selected from the face images stored in the analyzing section. As a result, the high-importance face images are searched at a high speed in the data-collection terminal device while a large amount of low-importance face images are searched in the analyzing section.

In the above-described device, the importance allocated to each of the face images follows instruction data inputted from an information input section. If the task of inputting the instruction data is troublesome, then a searching performance is deteriorated as a result.

### SUMMARY OF THE INVENTION

An object-image searching apparatus according to the present invention, comprises: a fetcher which fetches an object scene image; a first searcher which searches an object image that matches a registered object image from the object scene image fetched by the fetcher; an acceptor which accepts a designating manipulation for designating the object image on the object scene image fetched by the fetcher; a second searcher which searches a predetermined object image that matches the object image designated by the designating manipulation from among a plurality of predetermined object images; and a definer which defines, as the registered object image, the predetermined object image discovered by the second searcher.

An object-image searching program product according to the present invention is an object-image searching program product executed by a processor of an object-image searching apparatus, comprises: a fetching step of fetching an object scene image; a first searching step of searching an object image that matches a registered object image from the object scene image fetched by said fetching step; an accepting step of accepting a designating manipulation for designating the object image on the object scene image fetched by said fetching step; a second searching step of searching for a predetermined object image that matches the object image designated by the designating manipulation from among a plurality of predetermined object images; and a defining step of defining, as the registered object image, the predetermined object image discovered by said second searching step.

An object-image searching method according to the present invention is an object-image searching method executed by an object-image searching apparatus, comprises: a fetching step of fetching an object scene image; a first searching step of searching an object image that matches a registered object image from the object scene image fetched by said fetching step; an accepting step of accepting a designating manipulation for designating the object image on the object scene image fetched by said fetching step; a second searching step of searching a predetermined object image that matches the object image designated by the designating manipulation from among a plurality of predetermined object images; and a defining step of defining, as the registered object image, the predetermined object image discovered by said second searching step.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of one embodiment of the present invention;

FIG. 2 is a block diagram showing a configuration of one embodiment of the present invention;

FIG. 3 is an illustrative view showing one example of a state where an evaluation area is allocated to an imaging surface;

FIG. 4 is an illustrative view showing one example of a configuration of an extraction dictionary;

FIG. 5 is an illustrative view showing one example of a normal register referred to in face detecting behavior;

FIG. 6 is an illustrative view showing one example of a face-detection frame structure used for a face recognition process;

FIG. 7 is an illustrative view showing one portion of the face detecting behavior;

FIG. 8 is an illustrative view showing one example of an object scene captured by an imaging surface;

FIG. 9 is an illustrative view showing another example of the object scene captured by the imaging surface;

FIG. 10(A) is an illustrative view showing one example of a reproduced image;

FIG. 10(B) is an illustrative view showing one example of a reproduced image on which a zoom process and a scroll process are performed;

FIG. 11 is an illustrative view showing one example of a configuration of a general dictionary;

FIG. 12 is an illustrative view showing one example of a temporary register referred to in extraction-dictionary creating behavior;

FIG. 13 is an illustrative view showing another example of the configuration of the extraction dictionary;

FIG. 14 is an illustrative view showing still another example of the object scene captured by the imaging surface;

FIG. 15 is a flowchart showing one portion of behavior of a CPU applied to the embodiment in FIG. 2;

FIG. 16 is a flowchart showing another portion of the behavior of the CPU applied to the embodiment in FIG. 2;

FIG. 17 is a flowchart showing still another portion of the behavior of the CPU applied to the embodiment in FIG. 2;

FIG. 18 is a flowchart showing yet another portion of the behavior of the CPU applied to the embodiment in FIG. 2;

FIG. 19 is a flowchart showing another portion of the behavior of the CPU applied to the embodiment in FIG. 2;

FIG. 20 is a flowchart showing still another portion of the behavior of the CPU applied to the embodiment in FIG. 2;

FIG. 21 is a flowchart showing yet another portion of the behavior of the CPU applied to the embodiment in FIG. 2; and

FIG. 22 is a flowchart showing another portion of the behavior of the CPU applied to the embodiment in FIG. 2.

### DETAILED DESCRIPTION OF THE PREFERRED EMBODIMENTS

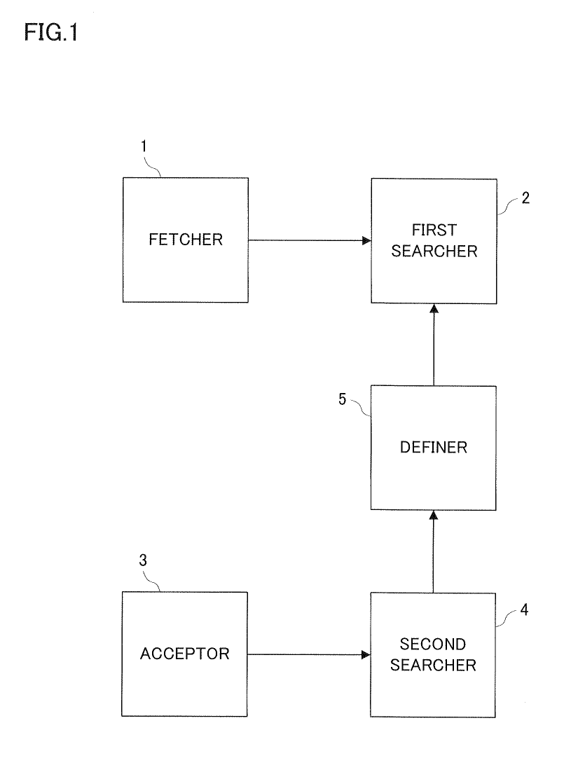

With reference to FIG. 1, an object-image searching apparatus of one embodiment of the present invention is basically configured as follows: A fetcher 1 repeatedly fetches an object scene image. A first searcher 2 searches an object image that matches a registered object image from the object scene image fetched by the fetcher 1. An acceptor 3 accepts a designating manipulation for designating the object image on the object scene image fetched by the fetcher 1. A second searcher 4 searches a predetermined object image that matches the object image designated by the designating manipulation from among a plurality of predetermined object images. A definer 5 defines, as the registered object image, the predetermined object image discovered by the second searcher 4.

Thus, when the object image on the object scene image is designated by the designating manipulation, the predetermined object image that matches the designated object image is searched from among the plurality of predetermined object images. The discovered predetermined object image is defined as the registered object image. The object image that matches this registered object image is thereafter searched from the object scene image. This improves a performance of searching a desired object image.

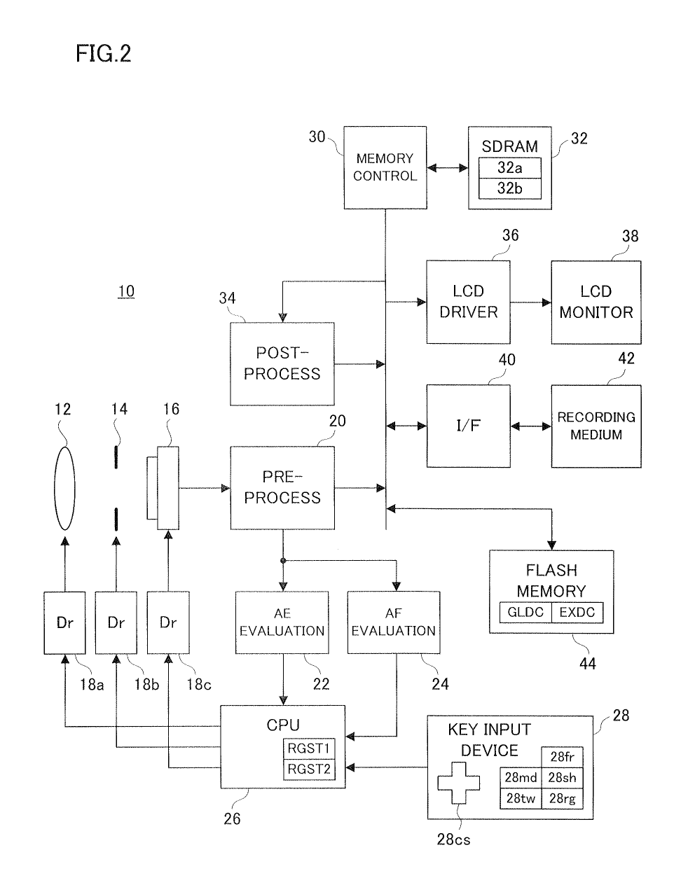

With reference to FIG. 2, a digital camera 10 according to this embodiment includes a focus lens 12 and an aperture unit 14 respectively driven by drivers 18a and 18b. An optical image of an object scene that undergoes these components enters, with irradiation, an imaging surface of an imager 16, and is subjected to a photoelectric conversion. Thereby, electric charges representing an object scene image are produced.

When a power source is applied, a CPU 26 determines a setting (i.e., an operation mode at a current time point) of a mode selector switch 28md arranged in a key input device 28, under a main task. If the operation mode at a current time point is a camera mode, then an imaging task and a face detecting task are started up, and if the operation mode at the current time point is a reproduction mode, then a reproducing task is started up.

When the imaging task is started up, the CPU 26 commands a driver 18c to repeat exposure behavior and electric-charge reading-out behavior in order to start a moving-image fetching process. In response to a vertical synchronization signal Vsync periodically generated from a Signal Generator (SG) not shown, the driver 18c exposes the imaging surface and reads out the electric charges produced on the imaging surface in a raster scanning manner. From the imager 16, raw image data based on the read-out electric charges is periodically outputted.

A pre-processing circuit 20 performs processes, such as digital clamp, pixel defect correction, and gain control, on the raw image data outputted from the imager 16. The raw image data on which these processes are performed is written into a raw image area 32a of an SDRAM 32 through a memory control circuit 30.

A post-processing circuit 34 reads out the raw image data accommodated in the raw image area 32a through the memory control circuit 30, and performs processes such as a white balance adjustment, a color separation, and a YUV conversion, on the read-out raw image data. The YUV-formatted image data produced thereby is written into a YUV image area 32b of the SDRAM 32 through the memory control circuit 30.

An LCD driver 36 repeatedly reads out the image data accommodated in the YUV image area 32b through the memory control circuit 30, and drives an LCD monitor 38 based on the read-out image data. As a result, a real-time moving image (through image) of the object scene is displayed on a monitor screen.

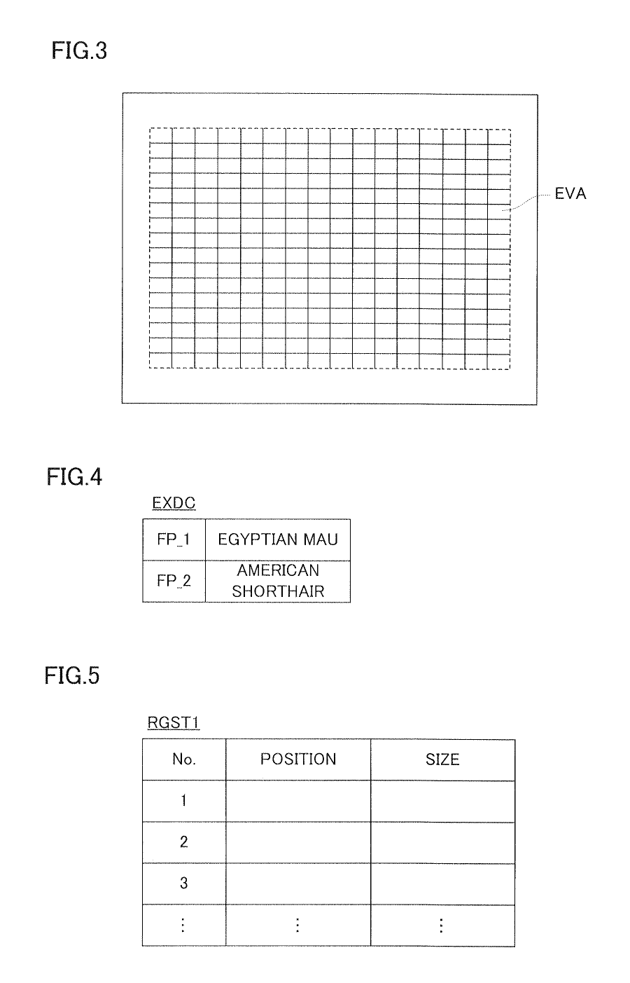

With reference to FIG. 3, an evaluation area EVA is allocated to a center of the imaging surface. The evaluation area EVA is divided into 16 portions in each of a horizontal direction and a vertical direction; therefore, 256 divided areas form the evaluation area EVA. Moreover, in addition to the above-described processes, the pre-processing circuit 20 executes a simple RGB converting process for simply converting the raw image data into RGB data.

An AE evaluating circuit 22 integrates RGB data belonging to the evaluation area EVA, out of the RGB data produced by the pre-processing circuit 20, at each generation of the vertical synchronization signal Vsync. Thereby, 256 integral values, i.e., 256 AE/AWB evaluation values, are outputted from the AE evaluating circuit 22 in response to the vertical synchronization signal Vsync.

Moreover, an AF evaluating circuit 24 extracts a high-frequency component of G data belonging to the same evaluation area EVA, out of the RGB data outputted from the pre-processing circuit 20, and integrates the extracted high-frequency component at each generation of the vertical synchronization signal Vsync. Thereby, 256 integral values, i.e., 256 AF evaluation values, are outputted from the AF evaluating circuit 24 in response to the vertical synchronization signal Vsync.

The CPU 26 executes a simple AE process that is based on the output from the AE evaluating circuit 22, in parallel with the moving-image fetching process, so as to calculate an appropriate EV value. An aperture amount and an exposure time period that define the calculated appropriate EV value are set to the drivers 18b and 18c, respectively. As a result, a brightness of the through image is adjusted moderately.

When a shutter button 28sh is half-depressed, the CPU 26 executes the AE process based on the output of the AE evaluating circuit 22 so as to calculate an optimal EV value. Similarly to the above-described case, an aperture amount and an exposure time defining the calculated optimal EV value are set to the drivers 18b and 18c, respectively. As a result, the brightness of the through image is adjusted strictly. Moreover, the CPU 26 executes an AF process that is based on the output from the AF evaluating circuit 24. The focus lens 12 is set to a focal point by the driver 18a, and thereby, a sharpness of the through image is improved.

When the shutter button 28sh is fully depressed, the CPU 26 starts up an I/F 40 for a recording process. The I/F 40 reads out one frame of image data representing an object scene that is obtained at a time point at which the shutter button 28sh is fully depressed, from the YUV image area 32b through the memory control circuit 30, and records the read-out image data on a recording medium 42 in a file format.

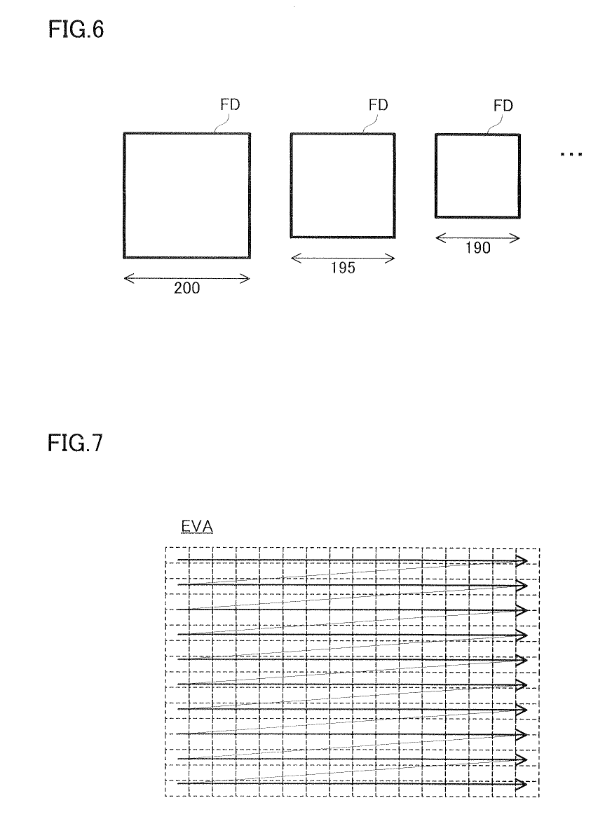

Under the face detecting task executed in parallel with the imaging task, the CPU 26 repeatedly searches a face image of an animal from the image data accommodated in the YUV image area 32b. For such a face detecting task, an extraction dictionary EXDC shown in FIG. 4, a normal register RGST1 shown in FIG. 5, and a plurality of face-detection frame structures FD, FD, FD, . . . shown in FIG. 6 are prepared.

According to FIG. 4, a characteristic of a face of an Egyptian Mau, which is one of the species of cats, is contained as a face pattern FP_1 in the extraction dictionary EXDC, and a characteristic of a face of an American Short Hair, which is another one of the species of cats, is contained as a face pattern FP_2 in the extraction dictionary EXDC. It is noted that in FIG. 4, English words of “Egyptian Mau” and those of “American Short Hair” are described. In reality, however, the characteristic of the face of the Egyptian Mau and that of the face of the American Short Hair are registered.

Furthermore, the normal register RGST1 shown in FIG. 5 is equivalent to a register used for describing the face-frame-structure information, and is formed by a column in which a position of the detected face image (a position of the face-detection frame structure FD at a time point at which the face image is detected) is described and a column in which a size of the detected face image (a size of the face-detection frame structure FD at a time point at which the face image is detected) is described.

Moreover, the face-detection frame structure FD shown in FIG. 6 moves in a raster scanning manner on the YUV image area 32b corresponding to the evaluation area EVA shown in FIG. 7 at each generation of the vertical synchronization signal Vsync. The size of the face-detection frame structure FD is reduced by a scale of “5” from “200” to “20” at each time that raster scanning is ended.

The CPU 26 reads out the image data belonging to the face-detection frame structure FD from the YUV image area 32b through the memory control circuit 30 so as to calculate a characteristic amount of the read-out image data. The calculated characteristic amount is checked with each of the face patterns FP_1 to FP_2 contained in the extraction dictionary EXDC. When a checking degree exceeds a threshold value TH, the position and the size of the face-detection frame structure FD at the current time point are registered, as face-frame-structure information, on the normal register RGST1.

When the raster scanning of the face-detection frame structure FD having a minimum size (=20) is ended, the CPU 26 detects the face-frame-structure information registered on the register RGST1, and issues a face-frame-structure character display command corresponding to the detected face-frame-structure information toward the LCD driver 36. However, in a case where there is no face-frame-structure information on the register RGST1, the issuance of the face-frame-structure character display command is cancelled. The LCD driver 36 displays a face-frame-structure character KF1 on the LCD monitor 38 by referring to the issued face-frame-structure character display command.

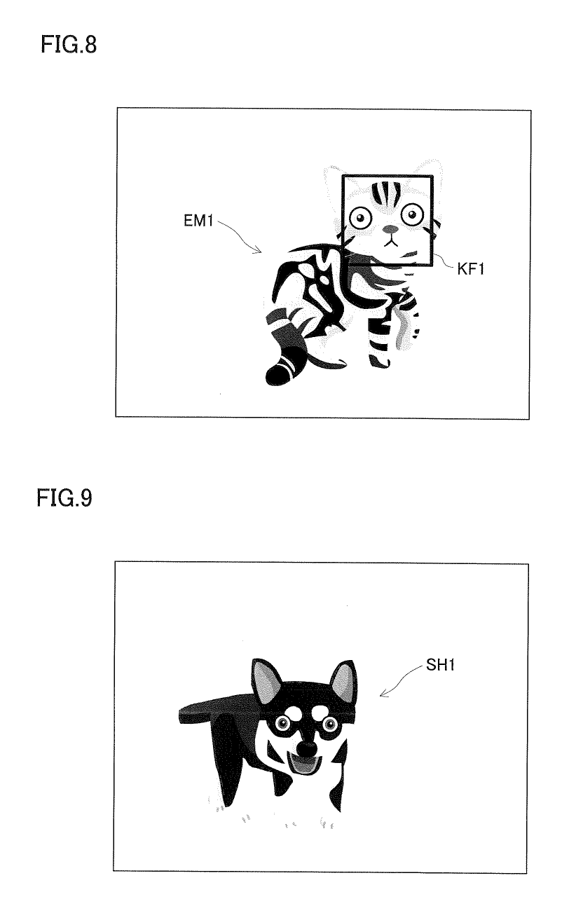

When an Egyptian Mau EM1 shown in FIG. 8 is captured on the imaging surface, the checking degree between the characteristic of the face image of the Egyptian Mau EM1 and the face pattern FP1 shown in FIG. 4 exceeds the threshold value TH. As a result, the face-frame-structure character KF1 is displayed at a position surrounding the face image of the Egyptian Mau EM1. In contrary, when a Siberian Husky SH1 shown in FIG. 9 is captured on the imaging surface, both checking degrees between the characteristic of the face image of the Siberian Husky SH1 and each of the face patterns FP1 and FP2 shown in FIG. 4 fall below the threshold value TH. At this time, the face-frame-structure character KF1 is non-displayed.

When the face-frame-structure character KF1 is displayed, the above-described AE process and AF process are executed by noticing the image within the face-frame-structure character KF1. On the other hand, when the face-frame-structure character KF1 is non-displayed, the above-described AE process and AF process are executed by noticing the whole image of the evaluation area EVA. Thus, imaging parameters such as an exposure amount and a focus are satisfactorily adjusted.

When the reproducing task is started up, the CPU 26 designates the latest image file recorded on the recording medium 42, as a reproduced-image file, and commands the I/F 40 and the LCD driver 36 to execute a reproducing process in which the designated image file is noticed.

The I/F 40 reads out the image data of the designated image file from the recording medium 42, and writes the read-out image data into the YUV image area 32b of the SDRAM 32 through the memory control circuit 30.

The LCD driver 36 reads out the image data accommodated in the YUV image area 32b through the memory control circuit 30, and drives the LCD monitor 38 based on the read-out image data. As a result, a reproduced image based on the image data of the designated image file is displayed on the LCD monitor 38.

Following such a reproducing process, the CPU 26 issues a registration-frame-structure character display command toward the LCD driver 36. With reference to the applied registration-frame-structure character display command, the LCD driver 36 displays a registration frame structure character RF1 at a center of the LCD monitor 38.

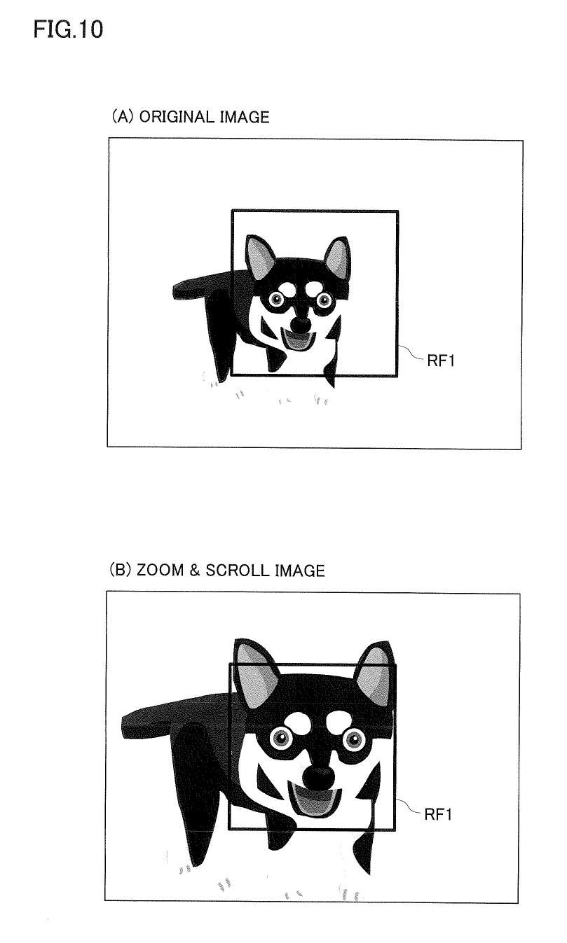

Therefore, when the image data representing an object scene shown in FIG. 9 is recorded on the recording medium 42 in the camera mode and this image data is reproduced from the recording medium 42 in the reproduction mode, the reproduced image and the registration frame structure character RF1 are displayed on the LCD monitor 38 as shown in FIG. 10(A).

When a forward/rewind button 28fr of the key input device 28 is manipulated, the CPU 26 designates a succeeding image file or a preceding image file as the reproduced-image file. The designated-image file is subjected to a reproducing process similar to that described above. As a result, the reproduced image is updated.

When a tele/wide button 28tw of the key input device 28 is manipulated, the reproduced image displayed on the LCD monitor 38 is reduced or expanded. Thereby, a magnification of the displayed image is changed. When a cross button 28cs of the key input device 28 is manipulated, the reproduced image displayed on the LCD monitor 38 is scrolled. Thereby, a position of the displayed image is changed.

Therefore, if the tele/wide button 28tw and the cross button 28cs are manipulated in a state where a reproduced image shown in FIG. 10(A) is displayed, then the reproduced image is transitioned from FIG. 10(A) to FIG. 10(B), for example.

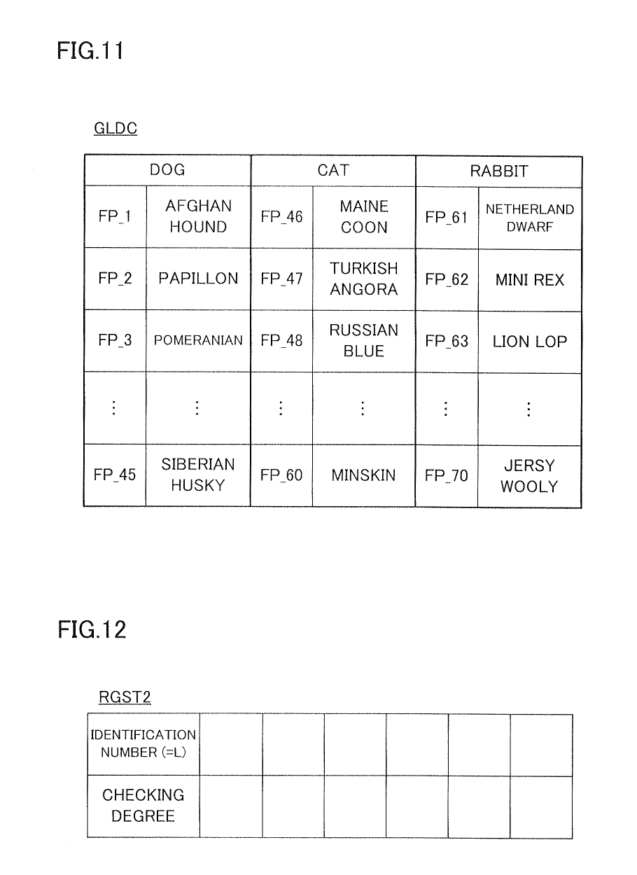

If a registration button 28rg of the key input device 28 is manipulated in a state where any one of the reproduced images is displayed, then in order to register one portion of the face patterns FP_1 to FP_70 contained in the general dictionary GLDC shown in FIG. 11, into the extraction dictionary EXDC, an extracting process is executed as follows.

In the general dictionary GLDC shown in FIG. 11, the face patterns FP_1 to FP_45 represent characteristics of faces of dogs of 45 species, respectively, the face patterns FP_46 to FP_60 represent characteristics of faces of cats of 15 species, respectively, and the face patterns FP_61 to FP_70 represent characteristics of faces of rabbits of 10 species, respectively.

In the extracting process, firstly, the image data belonging to the registration frame structure character RF1 is read out from the YUV image area 32b through the memory control circuit 30, and the characteristic amount of the read-out image data is calculated. The calculated characteristic amount is checked with each of the face patterns FP_0 to FP_70 contained in the general dictionary GLDC. An identification number of the face pattern of which the checking degree exceeds the threshold value TH, together with the checking degree, is registered on a temporary register RGST2 shown in FIG. 12.

Thus, if checking degrees equal to or more than “2” are registered on the temporary register RGST2, then top two checking degrees are detected from the temporary register RGST2, and the face patterns corresponding to the detected checking degrees are duplicated from the general dictionary GLDC into the extraction dictionary EXDC. It is noted that if the number of the checking degrees registered on the temporary register RGST2 is less than “2”, then an error process is executed.

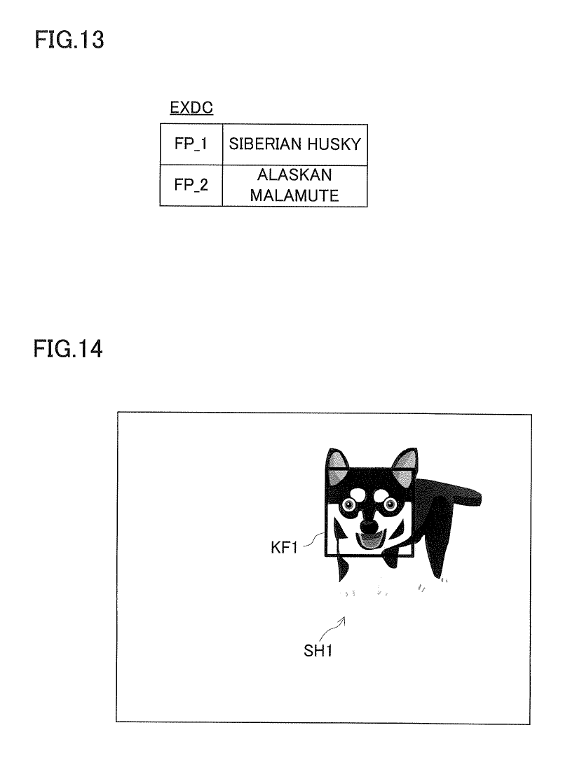

Therefore, if the extracting process is executed in a display state shown in FIG. 10(B), the extraction dictionary EXDC is updated from the state shown in FIG. 4 to a state shown in FIG. 13. According to FIG. 13, the characteristic of the face of the Siberian Husky, which is one of the species of the dogs, is contained in the extraction dictionary EXDC as the face pattern FP_1, and the characteristic of a face of an Alaskan Malamute, which is another one of the species of the dogs, is contained in the extraction dictionary EXDC as the face pattern FP_2.

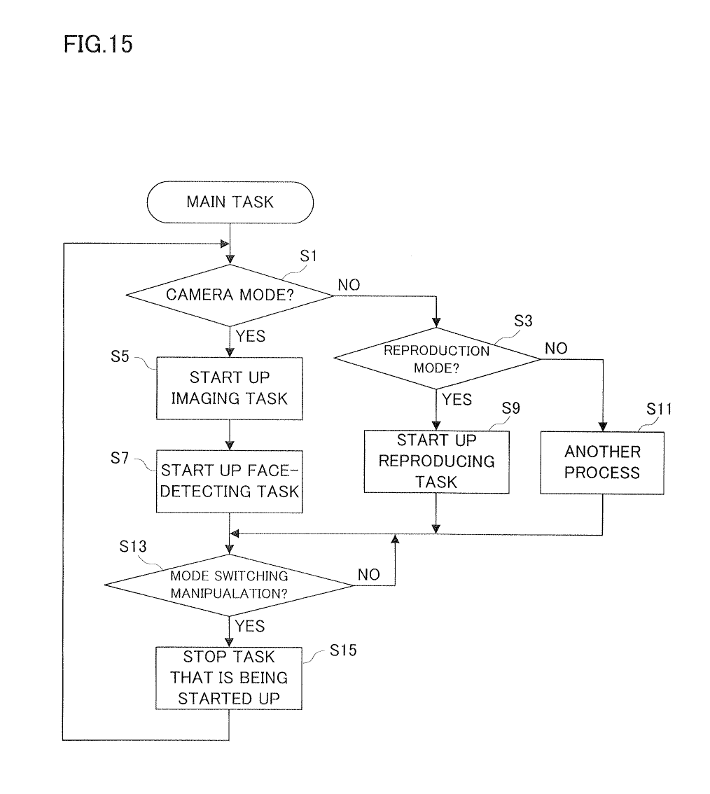

If the Siberian Husky SH1 is captured as shown in FIG. 14 in the camera mode established after the extraction dictionary EXDC is thus updated, then the face-frame-structure character KF1 is displayed at a position surrounding the face image of the Siberian Husky SH1.

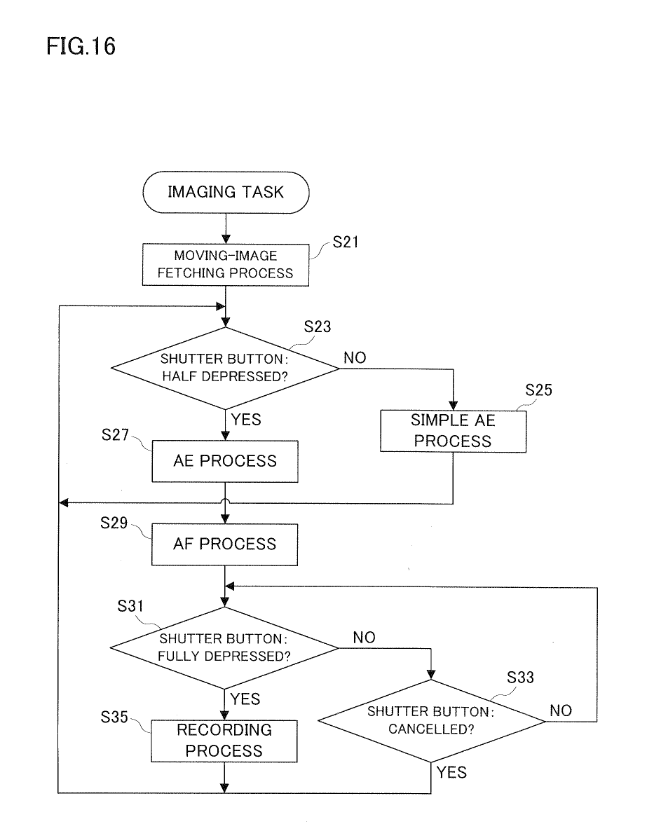

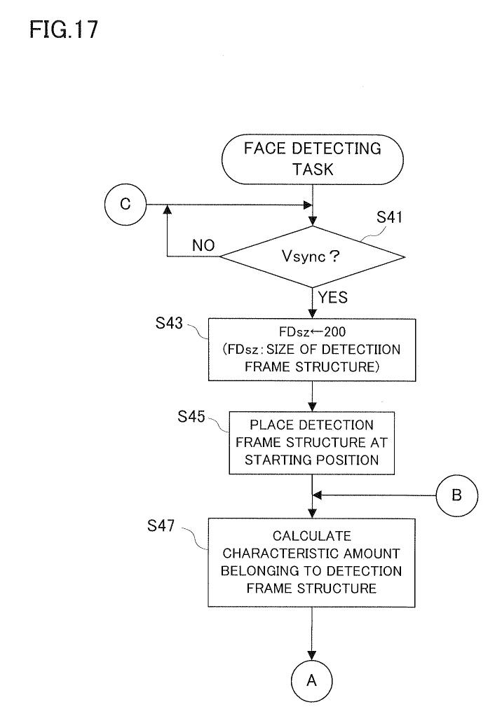

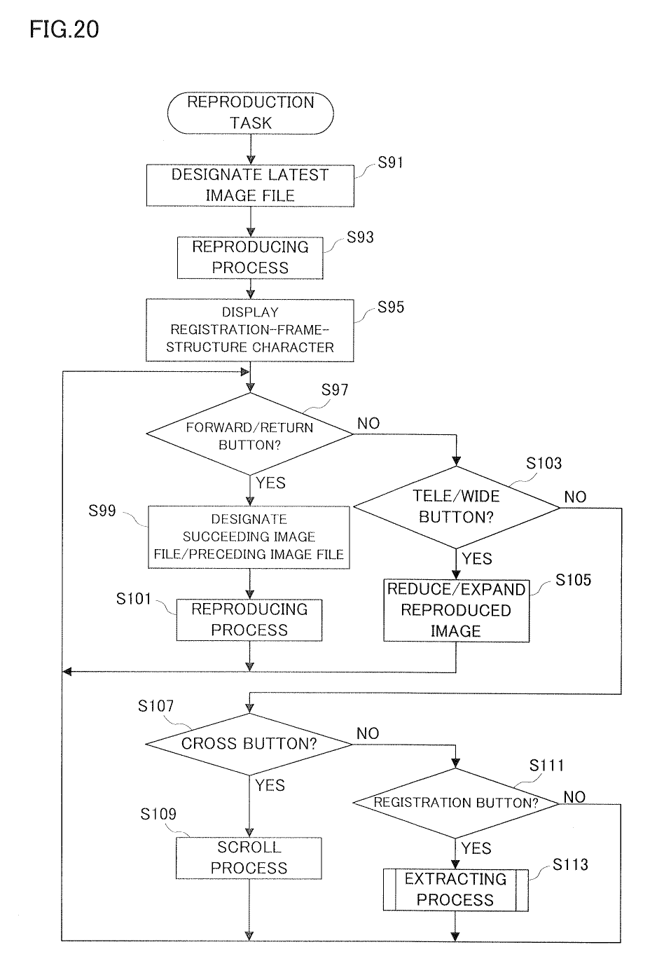

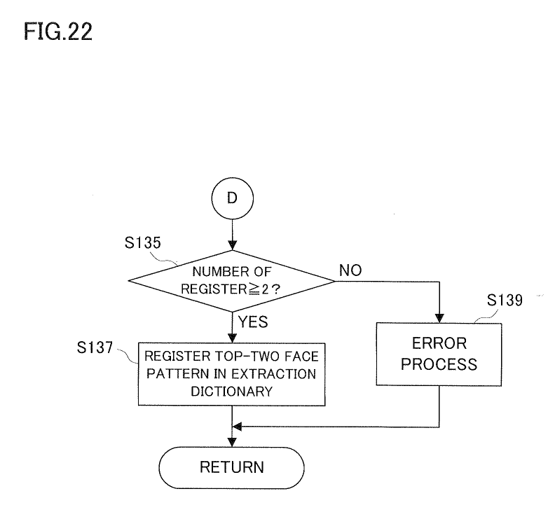

The CPU 26 executes a plurality of tasks including the main task shown in FIG. 15, the imaging task shown in FIG. 16, the face detecting task shown in FIG. 17 to FIG. 19, and the reproducing task shown in FIG. 20 to FIG. 22, in a parallel manner. Control programs corresponding to these tasks are stored in a flash memory 44.

With reference to FIG. 15, in a step S1, it is determined whether or not the operation mode at the current time point is the camera mode, and in a step S3, it is determined whether or not the operation mode at the current time point is the reproduction mode. When YES is determined in the step S1, the imaging task is started up in a step S5 and the face detecting task is started up in a step S7. When YES is determined in the step S3, the reproducing task is started up in a step S9. When NO is determined in both the steps S1 and S3, another process is executed in a step S11. Upon completion of the process in the step S7, S9, or S11, it is repeatedly determined in a step S13 whether or not a mode switching manipulation is performed. When a determined result is updated from NO to YES, the task that is being started up is stopped in a step S15. Thereafter, the process returns to the step S1.

With reference to FIG. 16, in a step S21, the moving-image fetching process is executed. As a result, the through image representing the object scene is displayed on the LCD monitor 38. In a step S23, it is determined whether or not the shutter button 28sh is half-depressed, and as long as a determined result is NO, a simple AE process in a step S25 is repeated. As a result, the brightness of the through image is adjusted moderately. When YES is determined in the step S23, the AE process is executed in a step S27 and the AF process is executed in a step S29. Thereby, the brightness and the focus of the through image are strictly adjusted.

In a step S31, it is determined whether or not the shutter button 28sh is fully depressed. In a step S33, it is determined whether or not the manipulation of the shutter button 28sh is canceled. When YES is determined in the step S31, the process advances to a step S35 so as to execute the recording process, and then, the process returns to the step S23. When YES is determined in the step S33, the process directly returns to the step S23. As a result of the recording process in the step S35, the image data representing the object scene at the time point at which the shutter button 28sh is fully depressed is recorded on the recording medium 42 in a file format.

With reference to FIG. 17, in a step S41, it is determined whether or not the vertical synchronization signal Vsync is generated. When a determined result is updated from NO to YES, the size of the face-detection frame structure FD is set to “200” in a step S43, and the face-detection frame structure FD is placed at a starting position (upper left of the evaluation area EVA) in a step S45. In a step S47, one portion of the image data belonging to the face-detection frame structure FD is read out from the YUV image area 32b, and the characteristic amount of the read-out image data is calculated.

In a step S49, a checking process for checking the calculated characteristic amount with each of the face patterns FP_1 and FP_2 contained in the extraction dictionary EXDC is executed. Upon completion of the checking process, it is determined in a step S51 whether or not the face-detection frame structure FD reaches an ending position (lower right of the evaluation area EVA).

When a determined result is NO, in a step S53, the face-detection frame structure FD is moved in a raster direction by a predetermined amount, and thereafter, the process returns to the step S47. When a determined result is YES, it is determined in a step S55 whether or not the size of the face-detection frame structure FD is reduced to “20”. When the determined result is NO, in a step S57, the size of the face-detection frame structure FD is reduced by “5”, and the face-detection frame structure FD is placed at a starting position in a step S59. Thereafter, the process returns to the step S47.

When a determined result in the step S55 is YES, the process advances to a step S61 so as to detect the face-frame-structure information described on the register RGST1 and issue the face-frame-structure character display command corresponding to the detected face-frame-structure information toward the LCD driver 36. However, in a case where there is no face-frame-structure information on the register RGST1, the issuance of the face-frame-structure character display command is cancelled. As a result, the face-frame-structure character KF1 is displayed on the through image in an OSD manner. Upon completion of the process in the step S61, the process returns to the step S41.

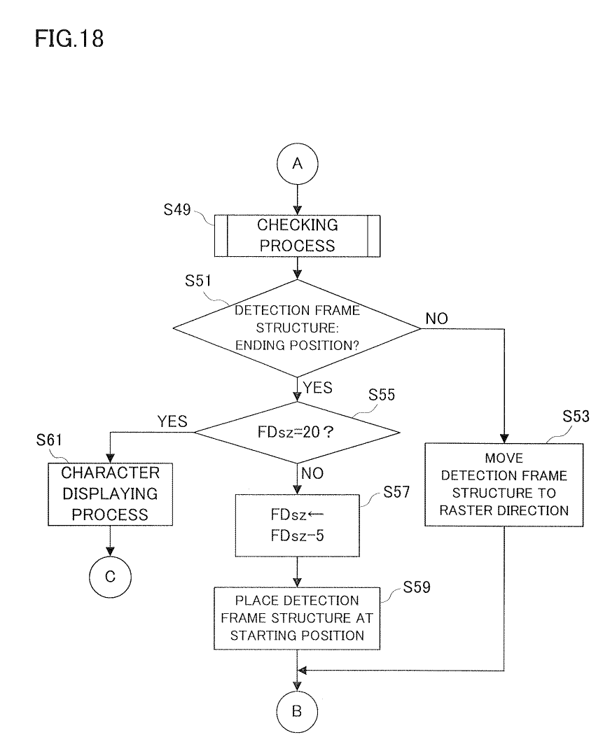

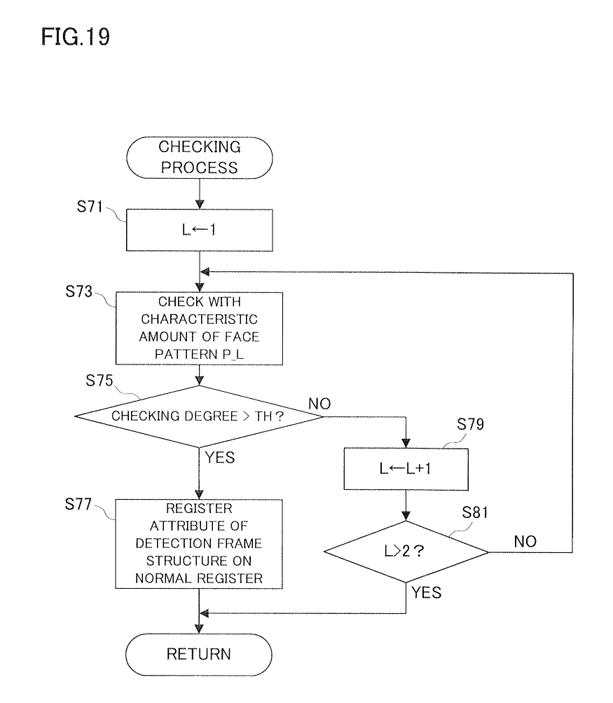

The checking process in the step S49 shown in FIG. 18 is executed according to a subroutine shown in FIG. 19. Firstly, in a step S71, a variable L is set to “1”. In a step S73, the characteristic amount of the image data belonging to the face-detection frame structure FD is checked with the face pattern FP_L contained in the extraction dictionary EXDC. In a step S75, it is determined whether or not the checking degree exceeds the threshold value TH.

When the determined result is NO, the variable L is incremented in a step S79. In a step S81, it is determined whether or not the incremented variable L exceeds “2”. Then, when L≦2 is established, the process returns to the step S73 while when L>2 is established, the process is restored to a routine at an upper hierarchical level. When YES is determined in the step S75, the process advances to a step S77 so as to describe the current position and the size of the face-detection frame structure FD, as the face-frame-structure information, on the register RGST1. Upon completion of the process in the step S77, the process is restored to the routine at the upper hierarchical level.

With reference to FIG. 20, in a step S91, the latest image file recorded on the recording medium 42 is designated, and in a step S93, the reproducing process in which the designated image file is noticed is executed. As a result, the reproduced image based on the image data accommodated in the designated image file is displayed on the LCD monitor 38. In a step S95, the LCD driver 36 is commanded to display the registration-frame-structure character RF1. As a result, the registration-frame-structure character RF1 is displayed on the through image in an OSD manner.

In a step S97, it is determined whether or not the forward/rewind button 28fr is manipulated. In a step S103, it is determined whether or not the tele/wide button 28tw is manipulated. Moreover, in a step S107, it is determined whether or not the cross button 28cs is manipulated, and in a step S111, it is determined whether or not the registration button 28rg is manipulated.

When a determined result in the step S97 is YES, the process advances to a step S99 so as to designate the succeeding image file or the preceding image file as a subsequent reproduced-image file. Upon completion of the process in the step S99, a reproducing process similar to that described above is executed in a step S101. Thereafter, the process returns to the step S97.

When a determined result in the step S103 is YES, the process advances to a step S105 so as to reduce or expand the reproduced image displayed on the LCD monitor 38. Thereby, the magnification of the displayed image is changed. Upon completion of the reducing/expanding process, the process returns to the step S97.

When a determined result in the step S107 is YES, the process advances to a step S109 so as to scroll the reproduced image displayed on the LCD monitor 38. Thereby, the position of the reproduced image to be displayed is changed. Upon completion of the scroll process, the process returns to the step S97.

When YES is determined in the step S111, the process advances to a step S113 so as to execute the extracting process for registering one portion of the face patterns FP1 to FP_70 contained in the general dictionary GLDC into the extraction dictionary EXDC. Upon completion of the extracting process, the process returns to the step S97.

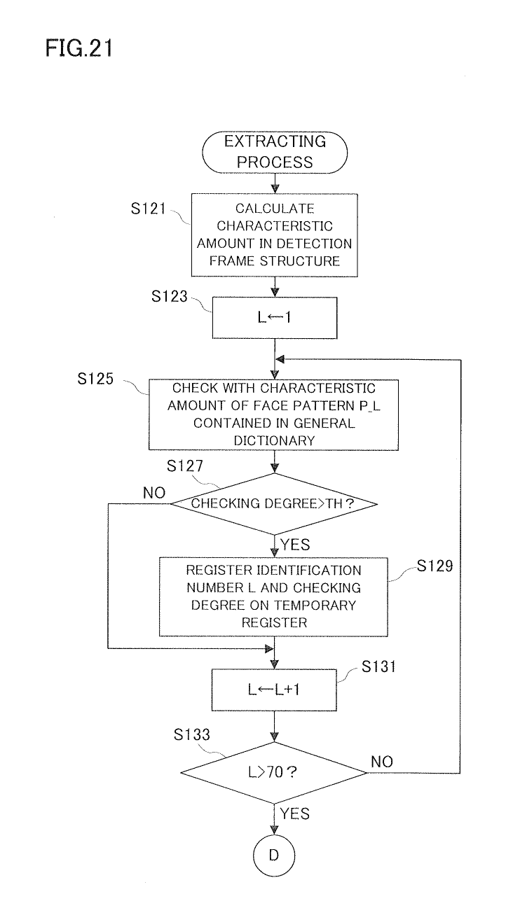

The extracting process in the step S113 is executed according to a subroutine shown in FIG. 21. In a step S121, one portion of the image data belonging to the registration-frame-structure character RF1 is read out from the YUV image area 32b, and the characteristic amount of the read-out image data is calculated. In a step S123, the variable L is set to “1”. In a step S125, the characteristic amount calculated in the step S121 is checked with the face pattern FP_L contained in the general dictionary GLDC.

In a step S127, it is determined whether or not the checking degree exceeds the threshold value TH. When a determined result is NO, the process directly advances to a step S131 while when the determined result is YES, the process advances to the step S131 via a process in a step S129. In the step S129, the identification number L and the checking degree associated with each other are registered on the temporary register RGST2.

In the step S131, the variable L is incremented. In a step S133, it is determined whether or not the incremented variable L exceeds “70” equivalent to the number of the face patterns registered in the general dictionary GLDC. When a determined result is NO, the process returns to the step S125, and when the determined result is YES, the process advances to a step S135.

In the step S135, it is determined whether or not the number of the checking degrees registered on the temporary register RGST2 is equal to or more than “2”. When a determined result is YES, the process advances to a step S137 while when the determined result is NO, the process advances to a step S139. In the step S137, the two face patterns corresponding to the top two checking degrees are detected from the general dictionary GLDC, and the detected face patterns are registered in the extraction dictionary EXDC. In the step S139, the error process is executed. Upon completion of the process in the step S137 or S139, the process is returned to a routine at an upper hierarchical level.

As can be seen from the above-described explanation, when the camera mode is selected, the CPU 26 fetches the object scene image captured by the imager 16 (S21), and searches the object image that matches the face pattern (registered object image) contained in the extraction dictionary EXDC from the fetched object scene image (S41 to S61). When the reproduction mode is selected, the CPU 26 reproduces the object scene image recorded on the recording medium 42, on the LCD monitor 38 (S91 to S101), and accepts the manipulations of the tele/wide button 28tw, the cross button 28cs, and the registration button 28rg as designating manipulation of the desired object image reproduced on the LCD monitor 38 (S103 to S111). The CPU 26 searches the face pattern that matches the object image designated by the designating manipulation from the plurality of face patterns (predetermined object images) contained in the general dictionary GLDC (S121 to S133), and contains the face pattern discovered thereby into the extraction dictionary EXDC (S135 to S139).

Thus, when the desired object image is designated by the designating manipulation, the face pattern that matches the designated object image is searched from among the plurality of face patterns contained in the general dictionary GLDC. The discovered face pattern is contained in the extraction dictionary EXDC, and after this time, the object image that matches this face pattern is searched from the object scene image. This improves a performance of searching the desired object image.

It is noted that in this embodiment, upon designation of the desired object image, the manipulations of the tele/wide button 28tw, the cross button 28cs, and the registration button 28rg are required. However, instead of these buttons being manipulated, touch manipulations on the monitor screen may be optionally required. Moreover, in this embodiment, the designating manipulation of the desired object image is accepted in the reproduction mode; however, the designating manipulation of the desired object image may also be optionally accepted in the camera mode. Furthermore, in this embodiment, a still camera which records a still image is assumed; however, it is possible to apply the present invention to a movie camera which records a moving image.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An object-image searching apparatus, comprising:
a fetcher which fetches an object scene image;
a first searcher which searches an object image that matches a registered object image from the object scene image fetched by said fetcher;
an acceptor which accepts a designating manipulation for designating the object image on the object scene image fetched by said fetcher;
a second searcher which searches a predetermined object image that matches the object image designated by the designating manipulation from among a plurality of predetermined object images; and
a definer which defines, as the registered object image, the predetermined object image discovered by said second searcher.

2. An object-image searching apparatus according to claim 1, further comprising a start-up controller which alternatively starts up said first searcher and said acceptor.

3. An object-image searching apparatus according to claim 2, further comprising:
a recorder which records the object scene image fetched by said fetcher; and
a reproducer which reproduces the object scene image recorded by said recorder, wherein said start-up controller includes a first start-up processor which starts up said first searcher in association with said recorder and a second start-up processor which starts up said acceptor in association with said reproducer.

4. An object-image searching apparatus according to claim 1, further comprising an imager which has an imaging surface on which an object scene is captured and which produces the object scene image, wherein said fetcher fetches the object scene image produced by said imager.

5. An object-image searching apparatus according to claim 4, further comprising an adjuster which adjusts an imaging condition by noticing the object image discovered by said first searcher.

6. An object-image searching apparatus according to claim 1, wherein the plurality of predetermined object images include a plurality of animal images respectively corresponding to a plurality of species and the designating manipulation is equivalent to a manipulation for designating an animal image.

7. An object-image searching program product executed by a processor of an object-image searching apparatus, the program product comprising:
a fetching step of fetching an object scene image;
a first searching step of searching an object image that matches a registered object image from the object scene image fetched by said fetching step;
an accepting step of accepting a designating manipulation for designating the object image on the object scene image fetched by said fetching step;
a second searching step of searching for a predetermined object image that matches the object image designated by the designating manipulation from among a plurality of predetermined object images; and
a defining step of defining, as the registered object image, the predetermined object image discovered by said second searching step.

8. An object-image searching method executed by an object-image searching apparatus, the method comprising:
a fetching step of fetching an object scene image;
a first searching step of searching an object image that matches a registered object image from the object scene image fetched by said fetching step;
an accepting step of accepting a designating manipulation for designating the object image on the object scene image fetched by said fetching step;
a second searching step of searching a predetermined object image that matches the object image designated by the designating manipulation from among a plurality of predetermined object images; and
a defining step of defining, as the registered object image, the predetermined object image discovered by said second searching step.
